(19) United States
(12) Patent Application Publication
(10) Pub. No.: US 2014/0207808 A1
(43) Pub. Date: Jul. 24, 2014

(54) Updating Non-Appendable Record

(71) Applicant: HEWLETT-PACKARD DEVELOPMENT COMPANY, L.P., (US)

(72) Inventor: Barry Matthew Sabsevitz, Fort Collins, CO (US)

(73) Assignee: HEWLETT-PACKARD DEVELOPMENT COMPANY, L.P., Houston, TX (US)

(21) Appl. No.: 13/745,820

(22) Filed: Jan. 20, 2013

(51) Int. Cl. G06F 17/30

(52) U.S. Cl. CPC G06F 17/30345
USPC 707/756

(57) ABSTRACT

A system includes a record updater to update an original appendable record to yield an updated appendable record. The system also includes a record converter to convert an original non-appendable record, conforming to a non-appendable format, to the original appendable record, and to convert the updated appendable record is converted to yield an updated non-appendable record conforming to the non-appendable format.

### BACKGROUND

The Unified Extensible Firmware Interface (UEFI) is a standardized specification for an extensible interface between a computer platform and an operating system. UEFI specifies a Common Platform Error Record (CPER) for reporting hardware errors. A CPER error record comprises a record header followed by M section descriptors followed by M sections. The order of the section descriptors matches the order of the sections. Each section descriptor includes an offset identifying the relative location of the respective section. Each section can include data relating to one or more hardware error events.

### BRIEF DESCRIPTION OF THE DRAWINGS

The following figures represent examples and not the invention itself.

FIG. 1 is a schematic diagram of media encoded to update a record in accordance with an example.

FIG. 2 is a flow chart of a record update process in accordance with an example.

FIG. 3 is a schematic diagram of a computer system before records have been updated in accordance with an example.

FIG. 4 is a schematic representation of a linked-list error record (LLER) of the computer system of FIG. 3 after a new section has been added in accordance with an example.

FIG. 5 is a schematic diagram of the computer system of FIG. 3 after records have been updated in accordance with an example.

FIG. 6 is a flow chart of a record-update process implementable on the computer system of FIG. 3 in accordance with an example.

### DETAILED DESCRIPTION

In a complex computer system, the health of hardware components may be monitored to ensure uninterrupted operation. In such a system, error entries may be added to an error record on a frequent basis. Updating a UEFI CPER record having M sections can involve adding an M+1^{st} section descriptor that can be inserted at the end of the previous M descriptors, the M sections are moved to make room for the M+1^{st} section descriptor, the M+1^{st} section is appended at the end of the M sections, the section pointers for the original M section descriptors are modified, and the section pointer for the M+1^{st} descriptor is set to point to the new section. The pointers for the original M section descriptors are modified because the respective sections to which they refer have been moved. Furthermore, there can be more than one record to update at a time. All these actions to add a record can constitute a substantial burden in a system that frequently adds entries to its UEFI CPER record.

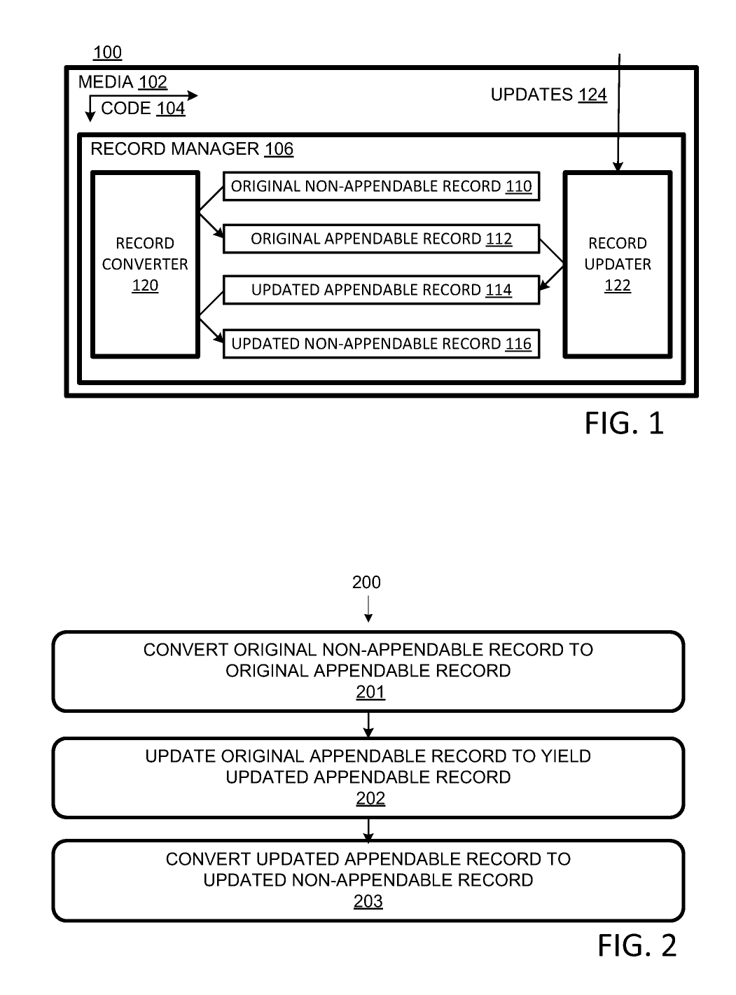

To mitigate this burden, a system 100, shown in FIG. 1, includes non-transitory storage media 102 encoded with code 104. Code 104, when executed by a processor defines a record manager 106 to manage data-storage records, including: an original non-appendable record 110, an original appendable-record 112, an updated appendable-record 114, and an updated non-appendable record 116. The original and the updated non-appendable records conform to the same non-appendable record format.

Herein, a record is “appendable” if data can be added without moving data already in the record. Herein, a record is “non-appendable” if existing data must be moved to add more data to the record. A UEFI CPER record is a non-appendable record, since adding a section requires that existing sections be moved.

Record manager 106 includes a record converter 120 and a record updater 122. Record converter 120 is used to convert a non-appendable record, e.g., original non-appendable record 110, to an appendable record, e.g., original appendable record 112, and to convert an appendable record, e.g., updated appendable record 114, to a non-appendable record, e.g., updated non-appendable record 116. Record updater 122 is to receive updates and to update an appendable record, e.g., original version appendable record 112 to yield updated version appendable record 114.

A record-update process 200, flow-charted in FIG. 2, can be implemented by executing code 104 or other code. At 201, an original non-appendable record is converted to an original version appendable record. At 202, the original appendable record is updated to yield an updated appendable record. At 203, the updated appendable record is converted to yield an updated non-appendable record. Note that code 124 can implement processes other than process 200.

Since the appendable record is appendable, unlike a CPER record, it is relatively easy to update, e.g., add or remove sections. The non-appendable record can be updated (e.g., replaced) once per many updates instead of once every update. This results in a considerable work saving, especially in computer systems in which updates are frequent and/or many records are being updated at once. The following example deals more specifically with CPER records, which conform to a non-appendable UEFI CPER format.

A computer system 300 includes a mission subsystem 302 and a management subsystem 304. Mission subsystem 302 is designed to carry out a user mission, e.g., by executing one or more user applications; management subsystem 304 is designed to manage, e.g., maintain the health of mission subsystem 302. Mission subsystem 302 and management subsystem 304 are each computers in their own rights, including hardware components such as storage media for storing code, a processor for executing and manipulating code, and communications devices to interface with each other, with other computer systems, and with users.

Mission subsystem 302 includes hardware components 310, UEFI firmware 312, one or more operating systems 314, and one or more applications 316 for carrying out user missions. UEFI firmware 312 allows CPER records to be generated for hardware components 310.

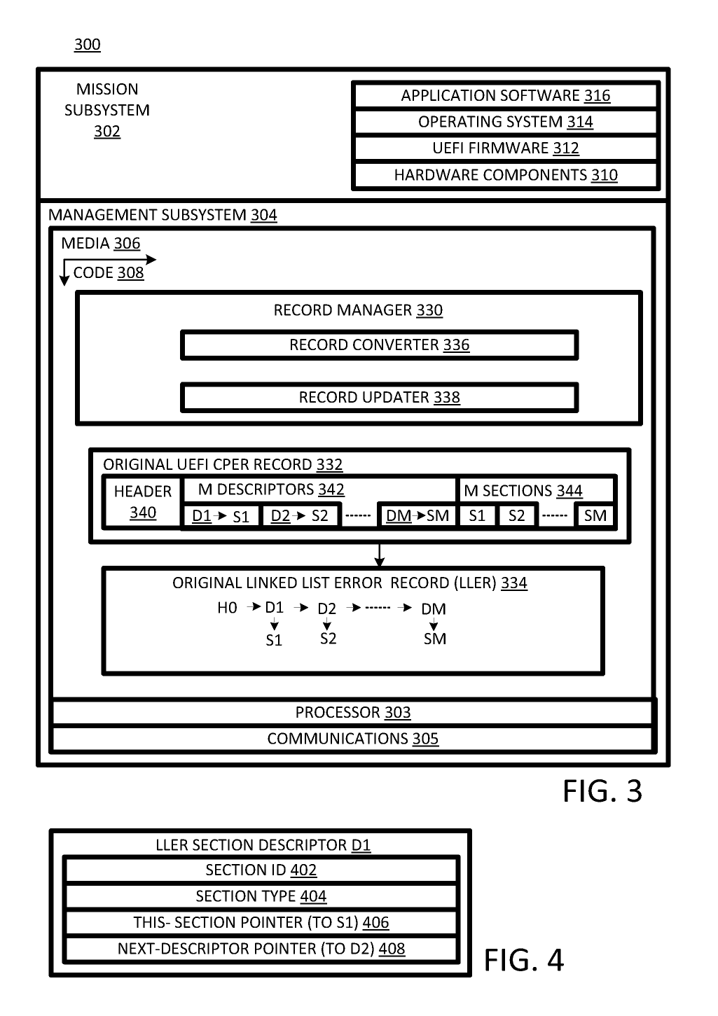

Management subsystem 304 includes a processor 303, communications devices 305, and non-transitory storage media 306. Media 306 is encoded with code 308 defining programs of instructions and non-instruction data. More specifically, code 308, at the time represented in FIG. 3, defines a record manager 330 (e.g., defines boot code that when executed generates record manager 330), an original UEFI CPER record 332, and an original linked-list error record (LLER) 334.

Record manager 330 includes a record converter 336 and a record updater 338. Record converter 336 converts in both directions between UEFI CPER records and linked list error records. Record updater 338 updates linked-list error records based on received error data.

Original UEFI CPER record 332 includes a header 340, M section descriptors 342 D1, D2, . . . DM, and M sections 344 of error data S1, S2, . . . SM, arranged sequentially in the illustrated order. Header 340 includes metadata specifying the size of UEFI CPER record 332 and the number (M) of descriptors 342 and of sections 344. Each section descriptor 342 specifies an offset at which the respective section 344 can be found.

To add a new section, e.g., section S(M+1), a corresponding descriptor D(M+1) would be created. Descriptor D(M+1) would be inserted after descriptor DM into a location formerly occupied by section S1. Thus, section S1 would have to be moved to accommodate descriptor D(M+1). In its new position, section S1 would occupy a location formerly occupied by section S2. Accordingly, section S2 would be moved, and so on, so that all sections including section SM would be moved. (This movement is a hallmark of a non-appendable record.) Since the existing sections S1-SM would have been moved, the offsets in the respective descriptors D1-D(M+1) would be modified. The new section S(M+1) would be arranged after section SM. The offset for descriptor S(M+1) would then be set to point to the location for section S(M+1).

Clearly, adding tens or hundreds of sections to UIEFI CPER record 332, one at a time, would be costly in terms of processor and real time. Record manager 330 avoids much of this cost by converting original UEFI CPER record 332 into original linked-list error (LLER) record 334, and then applying individual updates to LLER record 334 instead of UEFI CPER record 332. The format for LLER record 334 is shown in FIG. 3 for M sections S1-SM.

As shown in FIG. 4 for section descriptor D1, each section descriptor includes an identifier 402 for its respective section, an indication 404 of the section type, a “this-section” pointer 406 to its respective section, and a “next-descriptor” pointer to the immediately succeeding descriptor (if any). Thus, descriptor D1 points to section S1 and to descriptor D2. In the scenario of FIG. 3, descriptor DN has no successor, so its pointer for the successor descriptor is null. Header H0 includes a pointer to first section descriptor D1.

Whereas UEFI CPER record 332 is typically stored in persistent memory, LLER record 334 can be stored in volatile memory. Due to the use of pointers instead of offsets, items represented in LLER record 334 can be stored at arbitrary locations, e.g., in main memory directly addressable by a processor; in contrast, items in UEFI CPER record 332 are packed together in sequence as represented in FIG. 3.

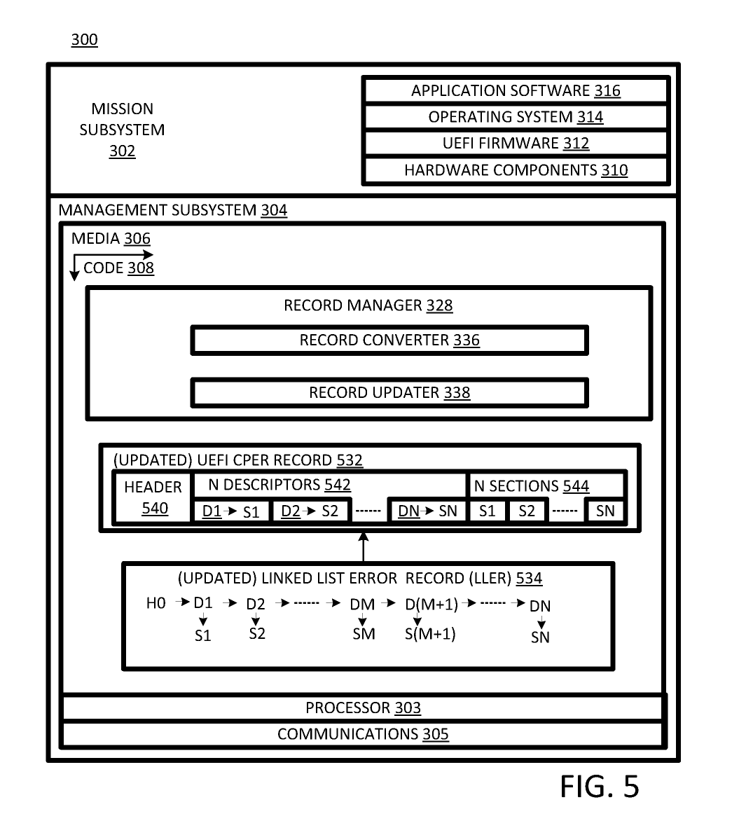

LLER record 334 record employs an appendable format. To add a section to LLER record 334, a new descriptor is added pointing to the new section. The only other modification is that the next-descriptor pointer for the previously last error item is modified to point to the new descriptor. For example, to add error section S(M+1), section S(M+1) can be stored at an arbitrary memory location. A descriptor D(M+1) for section S(M+1) can be created that points to the location for section S(M+1). None of the pre-existing sections S1-SM are moved, which qualifies LLER record 334 as appendable. The only modification to the pre-existing data is that descriptor DM is modified so that its next-descriptor pointer points to descriptor DM. The result for N-M updates is represented in FIG. 5.

New entries to LLER record 334 are accumulated before any conversion to a non-appendable format. Record manager 330 is typically aware of when all the updates relating to an error event have been received. At that point, the updated LLER record is converted by record format converter 336 to yield an updated UEFI-CPER record. Header HO can be modified to yield a UEFI CPER header and entered into a buffer. The next-descriptor pointers are followed to obtain all the section descriptors, which follow the header. The next-descriptor pointers are followed again to find the this-section pointers so that the respective sections can be appended to complete the updated UEFI-CPER record.

The result of the conversion from the updated appendable LLER record to the updated non-appendable UEFI-CPER record is shown in FIG. 5 for the case where N-M updates have been added to original LLER record 334 to yield updated UEFI CPER 532 with UEFI CPER header 540, N section descriptors 542, and N sections 544. In practice, tens or hundreds of updates to the original LLER record can take place before the conversion; however, the conversion itself is, in principle, the same regardless of the number of sections. Updated non-appendable UEFI-CPER record 532 can then be stored and/or transmitted as appropriate.

Updated non-appendable UEFI-CPER record 532 is, in effect, an updated version of original non-appendable UEFI-CPER record 332. Thus, original UEFI CPER record 320 is batch updated with multiple N-M new sections. However, there is no piecemeal modification of existing offsets (since the old descriptors are replaced in bulk). Thus, updating a UEFI-CPER record can be more performant when implemented indirectly via a linked list than when implemented directly.

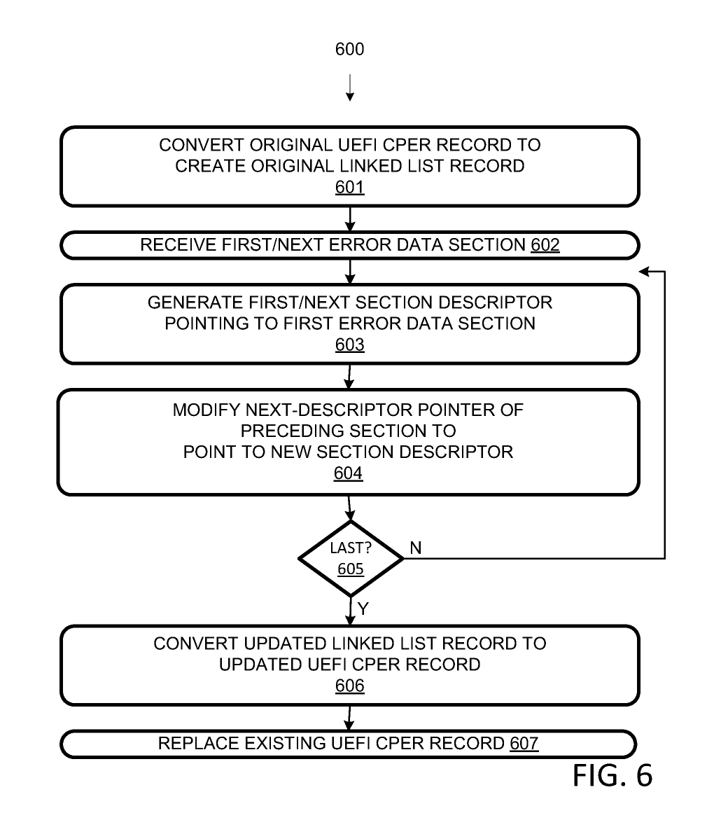

A process 600, implementable by computer system 300, is flow charted in FIG. 6. At 601, a linked list is created, e.g., by the record manager. If, at the time the linked list is created, the UEFI CPER record is not empty, then the linked list can be created by converting the UEFI CPER record to the link-list, e.g., using record converter 336. Otherwise, no conversion is required to create an empty linked list. An empty linked list can include a header, with a field for a next-descriptor pointer to the first descriptor, when it is input. Another alternative is to create a linked list with a single section when the first section is received at 602.

At 602, an error section is received. For example, error data may be generated at hardware component of the mission subsystem and then communicated to the record manager. The communication may involve transferring the error data using a socket. If the data is actually transferred, the error record manager can store the error data as an error-data section at either in persistent memory or volatile memory or both.

At 603, the record manager can generate and store a section descriptor for the new (just-received) section with a this-section pointer pointing to the new section. Typically, the new section descriptor has a null next-descriptor pointer, as, initially, there would not be a next section descriptor for a new section descriptor.

At 604, the new section descriptor is entered into the linked list. A next-descriptor pointer of an immediately preceding section descriptor or, in the case of a first section descriptor, header can be set so that it points to the new section descriptor.

At 605, a determination is made whether or not the new section is the last section to be entered into the LLER before the UEFI error record is to be synchronized. This determination can be based on knowledge of the record manager of the error data expected pursuant to an error notification from mission subsystem 302. If the new section is not the last section, process 600 returns to 602 for receipt of the next new section and actions 602-604 are repeated.

If, at 605, it is determined that the new section is the last section, then, at 606, the updated LLER record is converted to yield the updated UEFI CPER record. The linked list can be scanned to determine information, e.g., the number of sections and section descriptors, to be represented in header 540. The next-description pointers can be traced a first time so that the pointers can be appended one at a time beginning with the header. The next-description pointers and this-section pointers can be traced to locate the sections to be appended one at time after the section descriptors. The result is the desired updated UEFI CPER record, which is obtained without all the processing and performance hits that would otherwise be involved in applying multiple updates directly to a UEFI CPER record.

At 607, the updated UEFI CPER record overwrites or otherwise replaces the original UEFI CPER record. The updated UEFI CPER record can be stored and/or transmitted to a consumer for the record.

Herein, a “system” is a set of interacting non-transitory tangible elements, wherein the elements can be, by way of example and not of limitation, mechanical components, electrical elements, atoms, physical encodings of instructions, and process actions. Herein, “process” refers to a sequence of actions resulting in or involving a physical transformation.

Herein, “computer” refers to a hardware machine for physically encoded data in accordance with physically encoded instructions. Depending on context, reference to a computer may or may not include software installed on the computer. Herein, “device” refers to hardware. Herein, unless otherwise apparent from context, a functionally defined component (e.g., file manager, record converter, record updater) of a computer is a combination of hardware and software executing on that hardware to provide the defined functionality.

Herein, “storage medium” and “storage media” refer to a system including non-transitory tangible material in or on which information is or can be encoded with information including data and instructions. Herein, “processor” refers to hardware for executing instructions. A processor can be a monolithic device, e.g., integrated circuit, a portion of a device, e.g., core of a multi-core integrated circuit, or a distributed or collocated set of devices. Herein, “communications devices” refers to devices used for communication, including network devices, and devices used for input and output, e.g., human interface devices.

Herein, a “record” is a data structure for storing data, e.g., error data. A record “format” is a set of rules specifying what types of data are to be included in a record and how the parts of the record are to be arranged. Herein, “pointers” can have a null value, e.g., when there is nothing for them to point to, e.g., the next-descriptor pointer for the last section descriptor can be assigned a null value. Herein, “updating” can include adding and/or removing sections to/from a record.

In this specification, related art is discussed for expository purposes. Related art labeled “prior art”, if any, is admitted prior art. Related art not labeled “prior art” is not admitted prior art. The illustrated and other described embodiments, as well as modifications thereto and variations thereupon are within the scope of the following claims.

What is claimed is:

1. A record update process comprising:
converting an original non-appendable record into an original appendable record, said non-appendable record conforming to a non-appendable format;
updating the original appendable record with new sections to yield an updated appendable record; and
converting the updated appendable record to yield an updated non-appendable record conforming to the non-appendable format.

2. A process as recited in claim 1 wherein the original and updated appendable records are linked lists of section descriptors, the section descriptors including this-section pointers pointing to respective sections and next-descriptor pointers pointing to respective next section descriptions.

3. A process as recited in claim 2 wherein the original and updated non-appendable records are UEFI CPER records and the original and updated appendable records are linked-list records.

4. A process as recited in claim 2 wherein the updating includes modifying a next-descriptor pointer for a section descriptor for the immediate predecessor section so that the next-descriptor pointer points to a section descriptor for a new section.

5. A process as recited in claim 1 wherein the updating involves repeatedly updating to add plural sections without an intervening conversion to a non-appendable format.

6. A system comprising non-transitory storage media encoded with code to, when executed by a processor, define:
a record updater to update an original appendable record with new sections to yield an updated appendable record; and
a record converter to convert
an original non-appendable record into the original appendable record, said non-appendable record conforming to a non-appendable format, and
the updated appendable record to yield an updated non-appendable record conforming to the non-appendable format.

7. A system as recited in claim 6 further including the processor, the original appendable record being stored in volatile memory and the non-original appendable record being stored in persistent memory.

8. A system as recited in claim 6 wherein the original and updated appendable records are linked-list records and the original and updated non-appendable records are UEFI CPER records.

9. A system as recited in claim 8 wherein the original and updated linked-list records each includes section descriptors, each of which includes a this-section pointer pointing to a respective section, each of the section descriptors other than a last section descriptor pointing to a next section descriptor in the list, the UEFI CPER record including section descriptors including this-section pointers but not including next-descriptor pointers.

10. A system as recited in claim 6 wherein the original appendable record includes a header with a pointer pointing to a first section descriptor.

11. A computer system comprising:
a mission subsystem including hardware components to execute a user application;
a management subsystem to maintain the mission subsystem, the management subsystem including a processor, communications devices, and storage media, the storage media being collectively encode with code to, when executed by the processor, implement a record update process including:
converting an original UEFI-CPER record into an original linked-list;
updating the original link list at least in part by adding new sections to yield an updated linked list;
converting the updated linked list to yield an updated UEFI CPER record.

12. A computer system as recited in claim 11 wherein the original UEFI CPER is stored in persistent memory and the original linked list is stored in volatile memory.

13. A computer system as recited in claim 11 wherein the original and updated UEFI CPER records include section descriptors with offsets that point to respective sections, the section descriptors original and updated linked list both include section descriptors this-section pointers to a respective section, the linked list but not the UEFI CPER record including next-descriptor pointers pointing to other representations of section descriptors.

14. A computer system as recited in claim 11 wherein the original and updated linked lists includes headers including next-descriptors pointers pointing to respective first descriptors.
